(19) United States
(12) Patent Application Publication
(10) Pub. No.: US 2011/0245985 A1
(43) Pub. Date: Oct. 6, 2011

(54) Virtual Energy Meter for Automation and Historian Systems

(75) Inventor: Desmond Cooling, Dublin (IE)

(73) Assignee: Desmond Cooling, Dublin (IE)

(21) Appl. No.: 12/755,031

(22) Filed: Apr. 6, 2010

(51) Int. Cl. G06F 1/28

(52) U.S. Cl. 700/286

(57) ABSTRACT

The present invention relates to the provision of Energy consumption information with Virtual Energy Metering from Non-Energy metering data sources within Automation and Historian control systems. Through the use of a Virtual Energy Meter using an Energy Interface to communicate with various Automation or Historian control systems, devices such as motors and valves that do not have Energy monitoring functionality can provide Energy consumption information. The virtual energy meter converts Automation and Historian control data, such as device commands and feedback signals, into energy consumption information through the use of an energy translation method. The energy information is then made available for analysis through the virtual meters information data store. The advantage of the invention is that it removes numerous overheads associated with traditional energy metering such as the necessity for metering infrastructure, hardware, downtime and installation costs.

### TECHNICAL FIELD

The invention relates to the provision of Energy consumption information via Virtual Energy Metering from Non-Energy metering data sources within Automation and Historian Systems thus removing the need for the installation of a traditional energy metering device.

### BACKGROUND

In order for an organisation to identify and track Energy usage it is currently required to install a physical metering device such as an Electrical Power Meter, a Water Meter, a Steam Meter or any other form of WAGES (water, air, gas, electricity and steam) metering device into a building.

While such metering may exist at the top level of an organisations installation, such as a Power Distribution Board, there is rarely any sub-metering available on the actual users of Energy across a site. This leaves a data hole in the analysis of Energy use that in turn provides an incomplete Energy usage profile which fails to provide a complete Energy Map of users, consumptions and costs right across the organisation.

As traditional metering and sub-metering systems have a large financial and resource cost overhead in terms of physical metering devices, installation and plant downtime; many organisations are unable to justify the installation of such devices in order to track energy usage. Accordingly the need exists for an alternative method of Energy monitoring that can remove the necessity of traditional metering devices.

Automation and Historian systems are computer based monitoring, controlling and data storage applications and devices used for, but not limited to, Building Management Systems (BMS), Process Control Systems (PCS), Manufacturing Control Systems (MCS), Distributed Control Systems (DCS), Programmable Logic Control

Systems (PLC) and Supervisory Control and Data Acquisition Systems (SCADA). Automation and Historian systems consist of at least one Micro Computer Controller and a Human Machine Interface (HMI) monitoring and recording data from the process they control.

These processes can be diverse and range from HVAC systems (Heating Ventilation & Air Conditioning) to some form of complex Manufacturing Process such as Pharmaceutical and Brewing installations. In simplistic terms the Automation and Historian systems control and record the states of various devices used in these processes such as Pumps, Fans, Control Valves or any other device used in order to ensure the steady state conditions of the process are achieved.

The need exists to utilise this Automation and Historian system data in the generation of Energy consumption information so as to remove the overhead of a traditional metering system and to provide a cost effective approach to Energy Management. Other advantages of using Automation and Historian systems as Energy data sources are:
The existing automation and information technology (IT) infrastructure of an Organisation can be used
The automation data sources are reliable as they are controlling the process
The system is expandable to all forms of automation
Energy information can be backfilled from historical automation data stores
Time Period and Event based Energy consumption can be identified

It is therefore an object of the invention to provide a system and method for the effective use of Automation and Historian data in the generation of Energy consumption information.

### SUMMARY

According to the invention, there is a method of obtaining Energy consumption information using a virtual energy meter through the use of Automation and Historian data, the method comprising the steps of:
A virtual energy meter with an Energy Interface (EI) communicating with an Automation or Historian system
The virtual energy meter incorporates a definition for any type of WAGES, and provides a raw automation data translation technique to supply Energy consumption information for controlled devices
An Energy database used by the virtual energy meter as its configuration and data store for translated automation data
An advantage of the invention is that the EI of a virtual energy meter can communicate with any Automation and Historian system in order to obtain the raw data necessary for it to build an Energy profile value for any type of WAGES.

In one embodiment the EI uses Object Linking and Embedding for Process Control (OPC) as its communication protocol to Automation and Historian systems.

In another embodiment the EI uses Object Linking and Embedding for Databases (OLEDB) as its communication protocol to Automation and Historian systems.

In another embodiment the EI uses a Software Development Kit (SDK) as its communication protocol to Automation and Historian systems.

In another embodiment the EI uses an Application Programming Interface (API) as its communication protocol to Automation and Historian systems.

Preferably real-time and historical data is available to the virtual energy meter from the Automation and Historian data sources.

In one embodiment the virtual energy meter obtains real-time device data from the Automation or Historian system.

In another embodiment the virtual energy meter obtains historical device data from the Automation or Historian system.

In a further embodiment the virtual energy meter obtains both real-time and historical device data from the Automation or Historian system.

Preferably the virtual energy meter utilises raw automation data to build Energy profile information.

In one embodiment the virtual energy meter uses the automation command signal of a field device such as a motor or valve that is stored by the Automation or Historian system to determine its WAGES Energy usage profile.

In another embodiment the virtual energy meter uses the automation feedback signal of a field device such as a motor or valve that is stored by the Automation or Historian system to determine its WAGES Energy usage profile.

In another embodiment the virtual energy meter uses automation transmitter signals of a field device such as analogue or discrete transmitters stored by the Automation or Historian system to determine its WAGES Energy usage profile.

In another embodiment the virtual energy meter uses automation command signals, feedback signals and transmitter information from various field devices stored by the Automation or Historian system to determine the WAGES Energy usage profile.

Preferably the virtual energy meter uses time or event based analysis to build Energy consumption profiles over varying periods of time.

In one embodiment the virtual energy meter uses real time data and time periods to obtain current Energy consumption values.

In another embodiment the virtual energy meter uses historical data to obtain generic time based Energy consumption values for historical time periods such as hourly, daily, weekly, monthly and yearly windows.

In a further embodiment the virtual energy meter uses automation event conditions to obtain a time frame in order to build Energy consumption values for historical event based time periods such as production runs.

### BRIEF DESCRIPTION OF THE DRAWINGS

The invention will be more easily understood from the following description of some embodiments thereof, given by way of example only, with reference to the accompanying drawings, in which:

FIG. 1 is a simple process schematic used to explain some of the types of devices commonly used within a standard automation process that consume Energy and which the virtual energy meter translates to WAGES consumption;

FIG. 2 is a functional block diagram of multiple automation systems and a data historian system incorporating the virtual energy meter invention;

FIG. 3 is a flow chart of the virtual energy meter used for determining the energy consumption of a device for an event time frame, a current instant in time, an end of day total and an independent historical time period.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

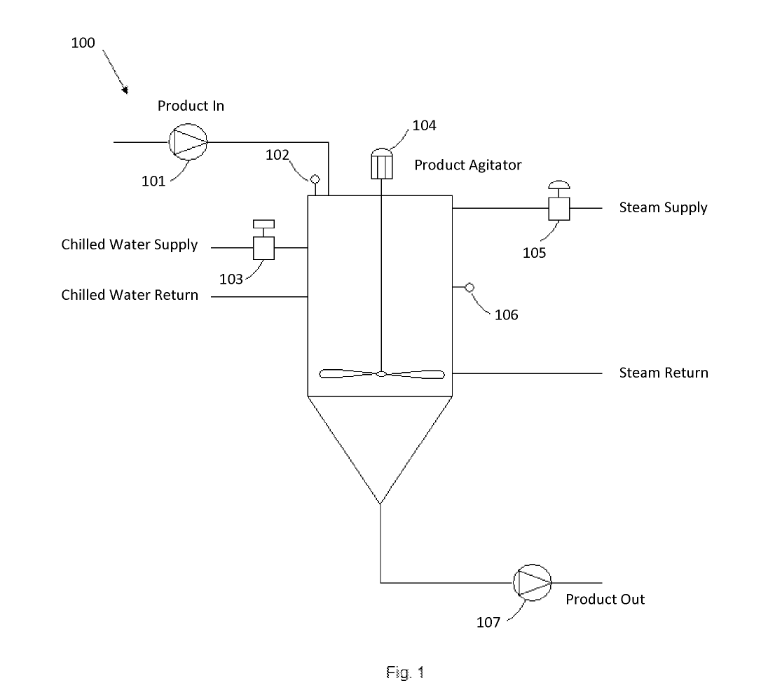

Referring to FIG. 1, a schematic (100) of a generic process controlled by an automation system is shown. The schematic (100) shows the overview of a Vessel arrangement containing a product transfer in pump (101), a level probe (102), a temperature probe (106), a chilled water supply valve (103), a steam control valve (105), a product agitator motor (104) and a product transfer out pump (107).

The following details a sample automation process for the equipment specified in FIG. 1. During standard production an automation system controls the process of product manufacture within the vessel. The automation system functions by controlling the relevant devices about the vessel while also using support devices within the overall process; for clarity only the vessel items are shown.

In this scenario a product will be added to the vessel using the transfer in pump (101) and have its temperature controlled using chilled water (103) and steam (105) based on information recorded from the temperature probe (106) and level probe (102).

Suitable agitation will also be applied to the product using the agitator motor (104). Upon completion of the production stage the product shall be moved on from the vessel through the product transfer out pump (107).

During this entire process energy is consumed by the various devices and product itself during manufacture. In this basic scenario we have power consumption by the product transfer in pump (101), the agitator motor (104) and the product transfer out pump (107). There is also steam energy consumption through the steam valve (105) and chilled water energy consumption through the chilled water valve (103).

For an organisation to sub-meter all these devices with a traditional metering system in order to track energy consumption and justify improvement projects it would require downtime, hardware and the installation of physical meters that can lead to excessive costs. With the use of a virtual energy meter for each device, all WAGES can be monitored with no hardware installation work required and zero downtime.

The virtual energy meter invention bases its WAGES energy consumption profile on the control of automation devices. By utilising this automation control data it is possible to obtain the instantaneous energy consumed by a device while active and the duration of activation (usage) of a device over varying periods of time.

The virtual energy meter translates a devices automation control data, such as a motor/valve command, a motor/valve feedback or any other form of automation control of a device, into an instantaneous energy consumption value. The total energy consumption of a device is then obtained using the duration of activation as the period of use.

The following example details how a virtual energy meter converts the characteristics of a device used by an automation process into Energy consumption information. By using a devices control data, a method of translation and duration of activation the total energy consumed is found. Motor power for a direct on-line (DOL) motor is the WAGES type profiled in this example.

From motor power equations the instantaneous full load power of a DOL motor can be equated as:

Pᵢ=\sqrt{3}VI cos θ a)

### Were:

Pᵢ is the motor instantaneous power consumption
V is the motor rated voltage
I is the motor rated current
θ is the phase angle between voltage and current of the motor

Using equation (a), the virtual energy meter instantaneous power reading for a device controlled by an automation system is equated as

P_{ν}=Pᵢ*α*β b)

### Were:

P_{ν} is the instantaneous virtual motor power consumption
Pᵢ is the instantaneous motor power consumption from equation (a)
α is the automation control status value of the device translated to a logical boolean value that provides a power consumption result if the device is active

| Automation Status | α value |
|---|---|
| Start Command | 1 |
| Running Feedback | 1 |
| Stop Command | 0 |
| Stopped Feedback | 0 |

β is a virtual energy meter correction factor ranging from +/−2 in steps of 0.01 used to adjust the value to a more accurate approximation.

As all WAGES have their own unique energy consumption formulae, equation (a) is dependent on the energy type to measure and its method of calculation. As such there are unlimited modifications and alternative forms of this equation for each type of WAGES energy, and indeed various equations for each specific WAGES energy type itself.

It should therefore be understood that the invention is not intended to be limited to the particular energy form detailed and its related equation. Rather, the invention is to cover all modifications, equivalents, and alternatives falling within the spirit and scope of the invention.

Thus for the virtual energy meter invention, equation (b) can be modified for the generic representation of all instantaneous WAGES energy consumption types

E_{ν}=Eᵢ*α*β c)

### Were:

E_{ν} is the instantaneous virtual energy consumption
Eᵢ is the sampled energy consumption of any type of WAGES
α is the automation control status value of the device translated to a logical boolean value that provides an energy consumption result if the device is active

| Automation Status | α value |
|---|---|
| Activate Command | 1 |
| Active Feedback | 1 |
| De-activate Command | 0 |
| Inactive Feedback | 0 |

β is a virtual energy meter correction factor ranging from +/−2 in steps of 0.01 used to adjust the value to a more accurate approximation.

Hence the total virtual energy consumption of any WAGES consuming device for a period of time is calculated by obtaining the instantaneous virtual energy value at predefined sample points over the devices usage time frame and integrating the subsequent result set to generate the total virtual energy consumed

Eₜ=∫ₜ₁^{t2}E_{ν}dt d)

### Were:

Eₜ is the total virtual energy consumed
E_{ν} is the sampled virtual energy consumed
t1 is the start time of device activation
t2 is the end time of device activation
dt is the sample point interval

The following details how the invention retrieves and uses automation data and time periods of a device from an Automation or Historian system to generate energy consumption information.

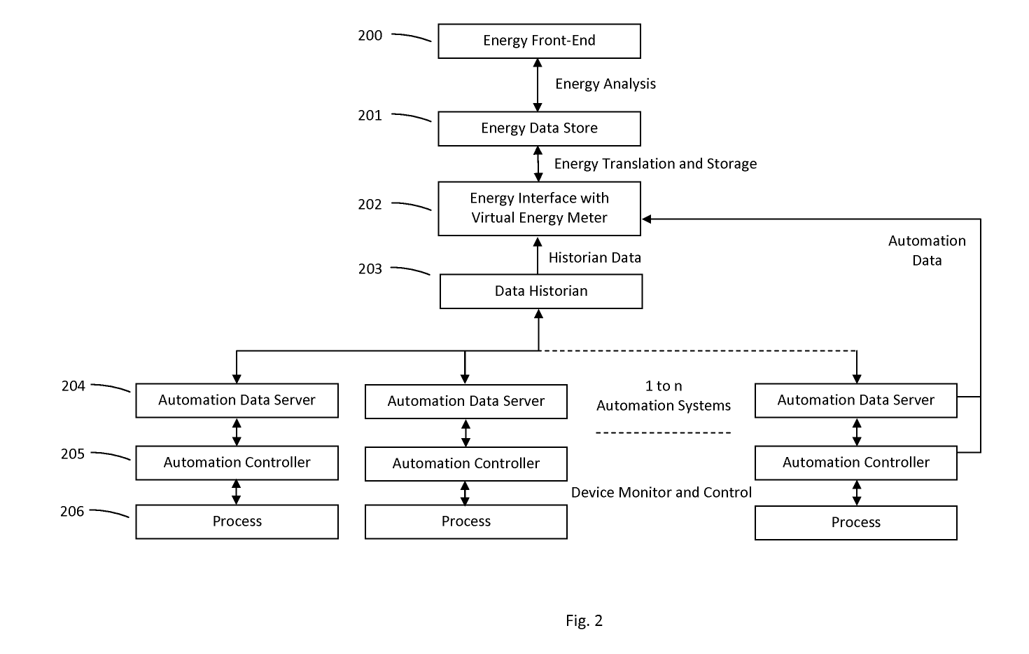

Referring to FIG. 2, the process (206) is a block representation of the example in FIG. 1. Although FIG. 1 refers to product manufacture in a vessel, the process block (206) is not limited to this specific example and could be any operational process. The virtual energy metering invention is used to track the control aspects of the devices within the process and translate this to energy information regardless of the process type.

Based on the configuration settings contained within the energy data store (201) the virtual energy meters configuration parameters and raw data source properties within the Automation or Historian system are set. Basic parameters for a energy virtual meter include its name, its equation for instantaneous energy conversion, its automation data source location, its time period or event period for querying and its sample point interval.

The virtual energy meter (202) then communicates directly with the automation controller (205) or the automation data server (204) or the data historian (203) using the communication protocols of OPC, OLEDB, SDK or API.

The relevant time based or event based queries are then used by the virtual energy meter (202) in order to obtain the required automation data over the predefined time periods.

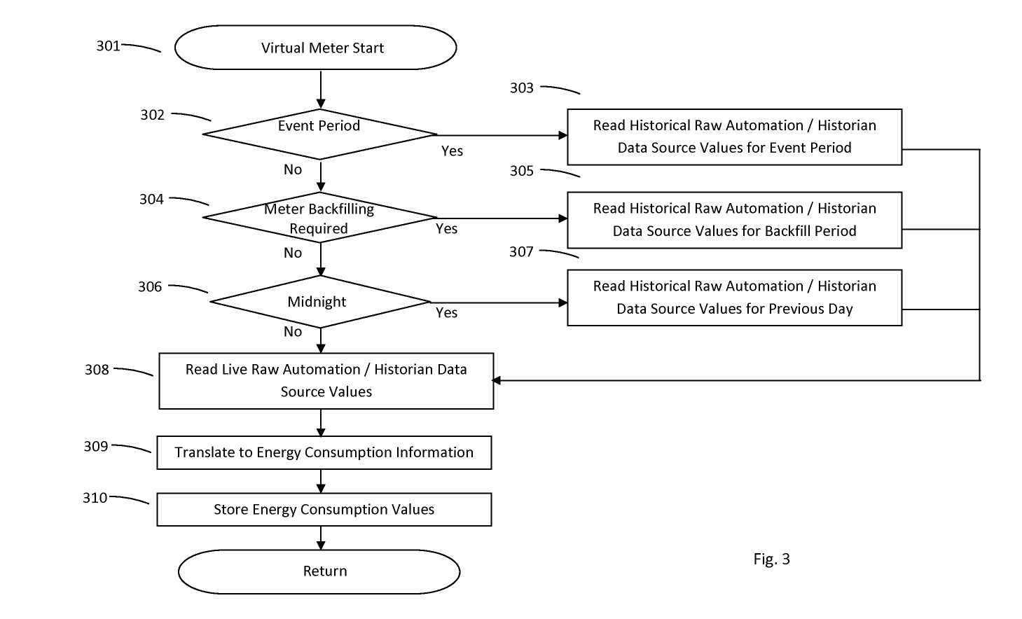

Referring to FIG. 3; the virtual energy meter first tests to determine if the data to be retrieved is based on an Event time period (302). Event conditions can vary but in summary they can be categorised as user events, automated events or bespoke events. Examples are user control events such as the manual start of a process or automated events such as process conditions being met. If it is an event time period, the required historical values are read from the Automation or Historian system data sources for the duration of the event period.

If the data to be retrieved is not event time based the virtual energy meter tests to determine if historical values are to be backfilled (304); that is historical energy information is to be generated for a period of time in the past. If backfilling is required historical values are read from the Automation or Historian system data sources for the time period required (305).

If the data to be retrieved is not historical in nature a test for midnight is performed (306). If the virtual energy meter determines that the midnight condition has occurred values are read from the Automation or Historian system data sources for the previous days 24 hour period (307).

The virtual energy meter also reads the current live values from the Automation or Historian system for the corresponding data sources of the virtual energy meter to determine the devices current state and consumption (308).

The virtual energy meter uses the current and historical values for any time period retrieved to translate the automation data to energy consumption information (309) through the use of equation (c) and equation (d). On translating this raw automation data to energy information the results are stored within the energy data store (310). This execution process loops continuously over time providing consistent energy consumption information for devices controlled by an automated process.

Referring to FIG. 2, through the virtual energy metering invention the automation data retrieved and translated to energy information in the data store (201) is now available to a front end display (200) for analytical purposes.

What is claimed is:

1. A method of automatically determining any form of Energy consumption by any device controlled by an automated control system without the need for physical metering through the use of a Virtual Energy Meter, comprising:
a communication protocol for Automation or Historian data sources,
a translation technique enabling the conversion of automation control data to Energy consumption information and,
a data store for configuration and energy consumption information.

2. A method as claimed in claim 1, to provide real-time instantaneous Energy consumption information and historical Energy information for any device controlled by an automation control system where this automation control data resides within computer memory, a file system or database medium.

3. A method as claimed in claim 2, to provide Energy consumption information over any predefined time period or event time period from historically stored automation control data.
